(19) United States
(12) Patent Application Publication
(10) Pub. No.: US 2019/0123343 A1
(43) Pub. Date: Apr. 25, 2019

(54) BULK SOLID STATE BATTERIES UTILIZING MIXED IONIC ELECTRONIC CONDUCTORS

(71) Applicants: Ford Global Technologies, LLC, Dearborn, MI (US); The Regents of The University of Michigan, Ann Arbor, MI (US)

(72) Inventors: Andrew Robert DREWS, Ann Arbor, MI (US); Venkataramani ANANDAN, Farmington Hills, MI (US); Jeffrey SAKAMOTO, Ann Arbor, MI (US)

(21) Appl. No.: 15/791,827

(22) Filed: Oct. 24, 2017

(51) Int. Cl. H01M 4/36; H01M 10/0525; H01M 10/0562

(52) U.S. Cl. CPC H01M 4/364; H01M 10/0525; H01M 2300/0071; H01M 10/0562; H01M 4/366

(57) ABSTRACT

An electrochemical cell including a positive electrode, a negative electrode, and a separator between the electrodes is disclosed. At least one of the electrodes includes a solid material having both ionically and electronically conductive properties.

### TECHNICAL FIELD

The present disclosure relates to bulk solid state batteries, and more particularly, materials used in bulk solid state batteries.

### BACKGROUND

Solid state batteries (SSBs) provide an alternative to conventional lithium-ion batteries. Typically, SSBs include solid electrodes and a solid electrolyte material. The solid electrolytes are resistant to lithium dendrites, which can lead to internal short circuits and are an alternative to flammable and unstable liquid battery electrolytes which can create a fire hazard. Solid electrolytes for SSBs are typically used as separators between the two electrodes and must be highly conductive to lithium ions, but have very low electronic conductivity. As a result, SSBs may have very low self-discharge rates. Because of the materials used, SSBs reduce the risk of electrolyte leakage and dangerous reactions between the electrolyte and active materials, as well as providing a long shelf life and high energy density.

### SUMMARY

According to an embodiment, an electrochemical cell includes a positive electrode, a negative electrode, and a separator between the electrodes. At least one of the electrodes includes a solid conductive material having both ionically and electronically conductive properties.

According to one or more embodiments, the separator may be a non-porous separator for conducting ions between the electrodes. The positive electrode may include a first solid conductive material and the negative electrode may include a second solid conductive material. Further, the first solid conductive material and the second solid conductive material may be different. The particles of the solid conductive material may be in contact with particles of active materials to form a single conductive network for ions and electronic charge carriers through at least one of the electrodes. The solid conductive material may be a homogenous mixed ionic electronic conductor. The solid conductive material may be a heterogeneous composite of separate ionically conductive particles and electronically conductive particles forming a single component functioning as a mixed ionic electronic conductor. The solid conductive material may be redox-inactive in the at least one electrode. The solid conductive material may be an electronically doped solid electrolyte, such as lithium lanthanum zirconium oxide (LLZO), perovskite, or NaSICON compound.

According to an embodiment, an electrochemical cell includes a positive electrode, a negative electrode, and a separator between the positive and negative electrodes. The positive electrode includes an active material and an electronically and ionically conductive solid material having a first redox potential. The negative electrode includes an active material and an electronically and ionically conductive solid material having a second redox potential different from the first.

According to one or more embodiments, the separator may be a non-porous separator for conducting ions between the electrodes. The solid materials may include mixtures of ionically conductive particles and electronically conductive particles which are in contact with particles of the active materials to form separate conductive networks for ions and electronic charge carriers through at least one of the electrodes. The solid material in at least one of the positive and negative electrodes may be a doped lithium lanthanum zirconium oxide (LLZO), perovskite, or NaSICON compound. The positive electrode and negative electrode may have different operating voltages, and the first conductivity and second conductivity may correspond to the operating voltages of each electrode, respectively.

According to an embodiment, an electrode for a solid state battery includes a current collector, particles of active material, and a solid conductive material on the current collector and surrounding the particles of active material. The solid conductive material is electronically and ionically conductive.

According to one or more embodiments, the solid conductive material may be a homogenous material with mixed ionic and electronic conductivity. The solid conductive material may be a heterogeneous composite of separate ionically conductive particles and electronically conductive particles forming a single component functioning as a mixed ionic electronic conductor. The solid conductive material may be an electronically doped lithium lanthanum zirconium oxide (LLZO), perovskite, or NaSICON compound. The solid conductive material may be redox-inactive in the electrode. The solid conductive material may be coated on the particles of active material.

### BRIEF DESCRIPTION OF THE DRAWINGS

FIG. 1 shows a schematic cross-section of an electrochemical cell according to an embodiment.

FIG. 2 shows a schematic cross-section of an electrode of an electrochemical cell according to an embodiment.

FIG. 3 shows a schematic cross-section of an electrochemical cell according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Solid state batteries (SSB) have the potential to provide high energy density and enhanced safety tolerance compared to existing lithium ion technologies. By relying on a solid electrolyte and eliminating the use of flammable liquid electrolytes, many of the risks associated with overcharge, over-temperature, or short circuit faults can be eliminated. Existing SSBs that have demonstrated performance and durability are fabricated with very thin electrode layers (<10 microns), and thus provide low capacities suitable for use only in low energy applications, such as smart-cards, medical implants, or other microscale uses.

For higher energy requirements, such as automotive traction energy storage, SSBs generally have thicker electrodes (e.g., 30-150 microns), compared to the 1-10 micron thick electrodes common in thin film batteries. Thick electrodes for lithium ion cell manufacturing are typically fabricated by casting slurries of powders to form a thick coating on a metallic current collector foil. Slurries containing both the active material, a binder and a conductive additive (carbon) are deposited onto metal current collector foils and dried to form the electrode. When assembled into a cell, the electrodes and separator are impregnated with a liquid electrolyte which provides ionic conductivity to particles of active material within the thick electrodes. In a SSB cell with thick electrodes, a solid electrolyte is incorporated into the electrode that provides ionic conduction to utilize the active material particles that are not in direct contact with the separator.

In addition to providing ionic conductivity through the thickness of an electrode in a SSB, electronic conductivity is needed through the thickness of each electrode to its respective current collector. In a typical Li-ion cell with a liquid electrolyte, electronic conduction across the thickness of the electrode proceeds through active material particles, across bridges between active material particles formed by the conductive additive, or across the surface of active material particles, aided by the conductive additive. This network of conductive carbon in a typical electrode is provided by addition of a relatively small percentage (3-5 wt. %) of the total solids content of the electrode. Engineering the characteristics of the two separate conduction channels within the electrodes is particularly difficult for an all-solid state battery cell.

Providing either conduction channel through the thickness of the electrode with a solid material may be difficult, since direct particle-to-particle contact is necessary for efficient conduction, either between conductive particles of solid material, or between conductive particles of solid material and the particles of the active material. Because both the electronic and ionic conduction additives require solid-solid contact with the active material particles, adding one component interferes with function of the other component.

If particles of active material, solid electrolyte, and conductive carbon are commingled in a slurry and cast and dried in the same fashion as used for Li-ion cell manufacturing, a thick electrode will have poor ionic conduction because of limited particle-to-particle contact, either between solid electrolyte particles, or between solid electrolyte and active material particles. Sintering the composite electrode at high temperatures in an oxygen containing atmosphere is likely to fail because of the high temperatures needed for sintering of the ceramic components (e.g., >800° C.) and the low reaction temperature (e.g., ˜450° C.) of carbon with oxygen. Performing the same operation in an inert environment may also fail because carbon at high temperatures is an effective reductant for many oxidized materials, such as the active material particles or the solid electrolyte. Reduction of the active or solid electrolyte materials will lead to a loss of electronic conduction, ionic conduction or both. This last problem might be overcome through the use of an oxide additive that is stable at high temperatures and electronically conductive, but examples with electronic conductivities similar to carbon are rare and often expensive.

In another method of constructing an electrode for an all-solid-state battery, active material particles and solid electrolyte particles are commingled in a common slurry which is cast and dried, either as a free-standing film or cast directly onto a solid electrolyte layer or metal current collector. As discussed above, because conduction through a random array of solid electrolyte particles or between solid electrolyte and active material particles is very inefficient, high temperature sintering is often discussed as a means to improve contact between the solid electrolyte particles. After sintering, an electronic conductor may be added by infusing a slurry of a conductive powder, such as carbon dispersed in a solvent. After deposition, the solvent is evaporated. Although sintering the mixture of active material and solid electrolyte improves the contact between solid electrolyte particles, and between solid electrolyte and active material particles, it also leads to a reduction of the exposed surface area of the active material particles and a reduction in the porosity of the solid. The loss of exposed surface area of the active material reduces contact of any conductive additive with the active material particles and hinders formation of efficient conduction networks through the electrode. In addition, sintering the active material with the solid electrolyte material brings their surfaces into intimate contact, but will inevitably lead to some closure of porosity that prevents access for the slurry to portions of the thickness of the electrode that are needed for incorporation of an electronic additive.

As described above, providing separate electron and ionic transport pathways through the thickness of the electrodes may be difficult to optimize if two separate materials are required for each function. The present disclosure relates to both electronic and ionic conduction pathways within the electrode using a single, mixed conductor material that simultaneous supports ionic and electron transport.

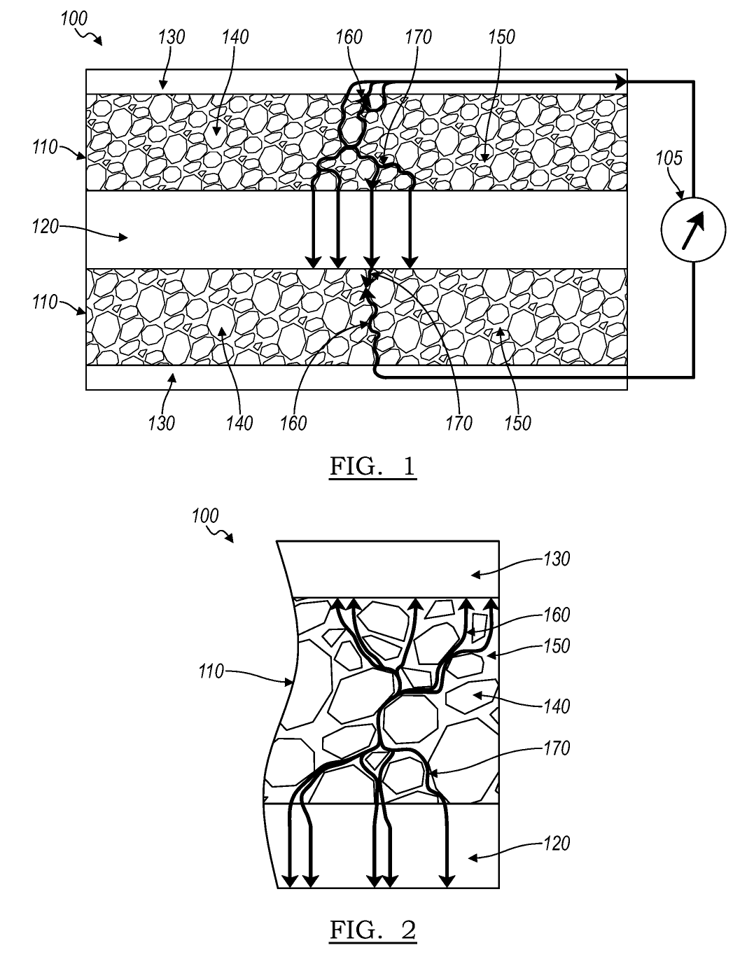

FIG. 1 depicts an electrochemical cell 100 according to an embodiment. The electrochemical cell 100 may be a primary, secondary, or rechargeable battery (e.g., a lithium-ion battery). The cell 100 includes electrodes 110 and a separator 120 there between. The electrodes 110 include a positive electrode (cathode) and a negative electrode (anode). The separator 120 may be a non-porous separator, having ionic conductivity for transporting ions between the electrodes 110. The separator may be formed from a solid electrolyte material. The separator 120 has negligible electronic conductivity or is not electronically conductive, and thus cannot exchange electrons between the electrodes 110. For example, the separator may include a solid electrolyte such as lithium lanthanum zirconium oxide (LLZO) that is un-doped and with negligible electronic conductivity. The solid electrolyte materials in each electrode may be in contact with the solid electrolyte material of the separator. The solid electrolyte materials of the electrodes and the separator form a continuous network throughout the battery for ion conduction. The electronically conductive and active material particles of the electrode may be in contact with a metallic current collector 130 adjacent to the electrode and forms a continuous network for electronic charge carriers through at least one of the electrodes. The current collector 130 connects the electrode 110 to an external device (e.g., a motor) 105. The current collectors 130 may be a metal or metal foil. Examples of suitable metals and metal foils may include, but are not limited to, copper, aluminum, stainless steel, nickel, gold, or titanium. The cell 100 may include additional components depending on the battery type or configuration.

The electrodes 110 include a solid electrolyte 150 and active material 140. In developing ionic conductors for use as separators between the anode and cathode, an important design criterion is to minimize the electronic conductivity of the material, since this can lead to self-discharge of the cell. However, within the thickness of the electrode, the choice of the solid electrolyte 150 is not limited by the need for low electronic conductivity as is the case for the separator. The solid electrolyte 150 may be a mixed conductor solid electrolyte which provides high ionic and high electronic conductivity. A mixed conductor may simultaneously support both ionic flow and electron flow, but in opposite directions within each electrode 110. Ionic pathways 170 and electronic pathways 160 are formed through the solid electrolyte 150, resulting in a conductive network. The solid electrolyte 150 is made of a mixed electronic ionic conductor (MEIC) material to form the ionic pathways 170 and the electronic pathways 160 in the electrode 110. The MEIC material may be a mixture of ionically conductive particles and electronically conductive particles forming a solid MEIC material. Because the conduction processes are not subdivided into two separate channels (as is with a liquid electrolyte used in combination with carbon electronic conductive additives), fewer restrictions are imposed on each conduction process. The conductive networks in each electrode may be formed each from solid materials that are redox-inactive in their respective electrodes, e.g., the solid materials should not undergo oxidation or reduction reaction.

FIG. 2 shows an electrode 110 of a portion of an electrochemical cell 100. During charge operation, as illustrated, the electrode 110 shown is a cathode. Lithium ions flow from the active material 140 particle towards the separator 120 via the ionic pathways 170. Electrons flow from the active material particle 140 towards the current collector 130 via electronic pathways 160. During the same operational state (charging), a particle of active material 140 in the anode (depicted in FIG. 1) will accept a lithium ion flowing on ionic pathway 170 from the separator 120, while simultaneously accepting an electron flowing on electronic pathway 160 from the anode current collector 130. In the discharge operation, the opposite flow directions occur for both the ions and electrons.

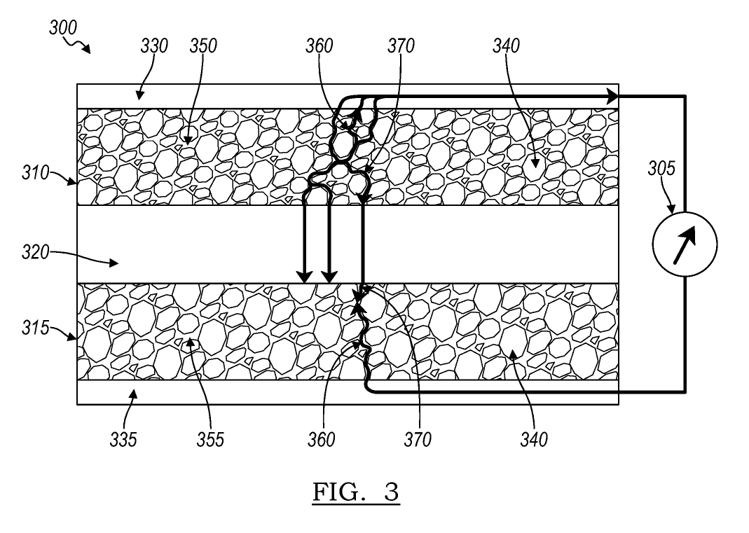

Referring again to FIG. 1, the MEIC material for the solid electrolyte 150 may be the same MEIC material for each electrode 110. In an embodiment, as shown in FIG. 3, different MEIC materials may be used for each electrode. FIG. 3 shows an electrochemical cell 300. The cell 300 includes a negative electrode 310, a positive electrode 315, and a separator 320 there between. The separator 320 is a non-porous separator, having ionic conductivity for transporting ions between the positive and negative electrodes (collectively, electrodes) 310, 315. The separator 320 cannot exchange electrons between the electrodes, e.g., separator 320 in the SSB is not electronically conductive. The negative electrode 310 has a current collector 330, connecting the negative electrode 310 to an external device 305. The positive electrode 315 has a current collector 335, connecting the positive electrode 315 to the external device 305. The current collectors 330, 335 may be a metal or metal foil. Examples of suitable metals and metal foils may include, but are not limited to, copper, aluminum, stainless steel, nickel, gold, or titanium. The cell 300 may include additional components depending on the battery type or configuration.

In the cell 300, each electrode includes a MEIC material 350, 355 and active material 140. The MEIC material 350, 355 provide ionic pathways 370 and electronic pathways 360. The MEIC material 350 for the negative electrode 310 may be different from the MEIC material 355 for the positive electrode 315. The choice of MEIC may differ for each electrode 310, 315 to accommodate chemical compatibility specific to each electrode. The MEIC may be selected to optimize the performance of each electrode independently. Referring again to FIG. 1, in certain embodiments, the same MEIC may serve adequately for both electrodes.

The MEIC material used in the SSB is redox-inactive in the respective electrode into which it is incorporated. The choice of MEIC for each electrode may be specific to the redox potential of the MEIC material, which corresponds to the electrode's operating voltage range, or operating potential, such as in FIG. 3. For example, the conductive solid material used in the electrodes should not undergo oxidation or reduction reaction in the operating potential range of that electrode, i.e., the redox potential of the conductive solid material in the electrode should lie outside the operating potential range of that electrode. Each electrode may have a MEIC material with a different redox potential outside of the operating potential range. Solid electrolyte materials may be tailored to function as MEIC materials by a variety of processes including, but not limited to, doping, or forming composites. Doping the solid electrolyte to form the MEIC includes doping the crystal structure with elements that alter the electronic band structure in such a way that occupied conduction states occur. Forming a composite MEIC includes combining a solid electrolyte material with an electronically conductive material. The use of doping may be applicable to a solid electrolyte material that may have various structures, including, but not limited to, crystalline, amorphous (glassy), or structures that contain aspects of both (e.g., materials which have regular repeating structures incorporating disorder features such as ion containing layers where the ions have no fixed order in the layer.)

Construction of electrodes to incorporate a MEIC material can be accomplished by several methods, including, but not limited to, co-deposition from a slurry made from a mixture of an active material and a MEIC, or over-coating a dried, porous electrode of active material with a slurry of MEIC. In other embodiments, active material and MEIC material may be co-deposited to form the electrode by, but not limited to, physical vapor deposition, thermal spraying electrodeposition, or powder mixing and compaction. In some embodiments, chemical precursors may be deposited in the form of a film and a post-deposition high temperature processing step may be used to sinter the components or induce reactions between precursors to achieve the final state. In other embodiments, a single component powder may be deposited which undergoes a reaction after deposition to decompose the precursor material into an active material and MEIC material as the solid electrolyte. In some embodiments, the MEIC material may be used in conjunction with liquid electrolytes, consist of a mixture of solid materials, or have a coating applied to the surfaces of the particles of the MEIC or active materials, or both.

MEIC material may be homogeneous (a single chemical compound) or heterogeneous (mixture of two or more compounds). In the field of solid oxide fuel cells, heterogeneous MEICs are typically made using a composite of Y₂O₃-doped ZrO₂ (oxygen ion conductor) with Ni (electronic conductor). An example of a homogeneous MEIC used in some solid oxide fuel cells is La₁₋ₓSrₓFe_{0.2}Co_{0.8}O₃. In the preparation of semiconductor detectors for X-rays and gamma-rays, lithium drifting is used as means to dope a semiconductor (Si or Ge). Lithium can be easily transported through the bulk of a crystal of the semiconductor under a potential to affect a desired doping distribution at high temperatures where the ionic diffusivity is high, then quenching the doped crystal to freeze the lithium distribution in place before removing the potential. To produce electroactive glass, a MEIC LiWO₃ is often used as a means to temporarily produce a region that is metallic within the thickness of the glass by applying a potential across the thickness of the glass using blocking electrodes. Battery active materials (such as Li₂MnO₄) are technically MEICs, since they can support transport of both Li⁺ ions and electrons, though they are not generally regarded as practical examples of such because of the low diffusivity of Li⁺ ions and their ability to store Li⁺ ions by a change in the redox state of the transition metal. Thus, while particles of Li-intercalation compounds are capable of transporting Li⁺ ions from particle to particle when fully lithiated, they act to store Li⁺ ions up to the point that they are fully lithiated and have such low Li⁺ ion diffusivities that they have concentration gradients where particles do not equilibrate at reasonable time-scales. A more practical definition of a MEIC is one in which the electronic and ionic conductivities are within two orders-of-magnitude.

Homogeneous MEICs for Li-SSBs include solid electrolytes having optimized ionic conductivity, which are modified to introduce electronic conductivity. The solid electronically conductive material in an electrode may be a modification of a lithium lanthanum zirconium oxide (LLZO) compound, a perovskite (lithium, lanthanum, titanium, oxygen) compound, or a NaSICON (lithium, titanium, phosphorous, oxygen) compound, doped with an element to provide electronic charge carrier, while also providing high ionic conductivity. For example, a Li-solid electrolyte is Li₇La₃Zr₂O₁₂ (LLZO), which adopts the garnet crystal structure. The family of compounds sharing this same garnet structure is quite large and amenable to substitution and doping with a wide range of elements. In one embodiment, LLZO may be doped with elements to introduce electrons which may occupy valence states and effect electronic conductivity (i.e., electronically doped). In other embodiments, other ionically optimized solid electrolytes may be doped to introduce electronic conductivity. In other embodiments, a heterogeneous MEIC may be produced by forming composites of solid electrolytes and electronic conductors directly as previously discussed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electrochemical cell comprising:
a positive electrode;
a negative electrode; and
a separator between the positive and negative electrodes,
wherein at least one of the electrodes includes a solid conductive material having both ionically and electronically conductive properties.

2. The electrochemical cell of claim 1, wherein the separator is a non-porous separator for conducting ions between the electrodes.

3. The electrochemical cell of claim 1, wherein the positive electrode includes a first solid conductive material and the negative electrode includes a second solid conductive material.

4. The electrochemical cell of claim 3, wherein the first solid conductive material and the second solid conductive material are different.

5. The electrochemical cell of claim 1, wherein particles of the solid conductive material are in contact with particles of active materials to form a single conductive network for ions and electronic charge carriers through at least one of the electrodes.

6. The electrochemical cell of claim 1, wherein the solid conductive material is a homogenous mixed ionic electronic conductor.

7. The electrochemical cell of claim 1, wherein the solid conductive material is a heterogeneous composite of separate ionically conductive particles and electronically conductive particles forming a single component functioning as a mixed ionic electronic conductor.

8. The electrochemical cell of claim 1, wherein the solid conductive material is redox-inactive in at least one electrode.

9. The electrochemical cell of claim 1, wherein the solid material is an electronically doped solid electrolyte selected from the group consisting of lithium lanthanum zirconium oxide (LLZO), perovskite, and NaSICON compound.

10. An electrochemical cell comprising:
a positive electrode including an active material and an electronically and ionically conductive solid material having a first redox potential;
a negative electrode including an active material and an electronically and ionically conductive solid material having a second redox potential different from the first redox potential; and
a separator between the positive and negative electrodes.

11. The electrochemical cell of claim 10, wherein the separator is a non-porous separator for conducting ions between the electrodes.

12. The electrochemical cell of claim 10, wherein the solid materials include mixtures of ionically conductive particles and electronically conductive particles which are in contact with particles of the active materials to form separate conductive networks for ions and electronic charge carriers through at least one of the electrodes.

13. The electrochemical cell of claim 10, wherein the solid material in at least one of the positive and negative electrodes is a doped solid electrolyte selected from the group consisting of lithium lanthanum zirconium oxide (LLZO), perovskite, and NaSICON compound.

14. The electrochemical cell of claim 10, wherein the positive electrode and negative electrode have different operating voltages, and wherein the first redox potential and second redox potential correspond to the operating voltages of each electrode, respectively.

15. An electrode for a solid state battery comprising:
a current collector;
particles of active material; and
a solid conductive material on the current collector and surrounding the particles of active material, the solid conductive material being electronically and ionically conductive.

16. The electrode of claim 15, wherein the solid conductive material is a homogenous material with mixed ionic and electronic conductivity.

17. The electrode of claim 15, wherein the solid conductive material is a heterogeneous composite of separate ionically conductive particles and electronically conductive particles forming a single component functioning as a mixed ionic electronic conductor.

18. The electrode of claim 15, wherein the solid conductive material is an electronically doped solid electrolyte selected from the group consisting of lithium lanthanum zirconium oxide (LLZO), perovskite, and NaSICON compound.

19. The electrode of claim 15, wherein the solid conductive material is redox-inactive in the electrode.

20. The electrode of claim 15, wherein the solid conductive material is coated on the particles of active material.
